(19) United States
(12) Patent Application Publication
(10) Pub. No.: US 2011/0080346 A1
(43) Pub. Date: Apr. 7, 2011

(54) LETTER INPUT DEVICE AND MOBILE TERMINAL INCLUDING THE SAME

(76) Inventor: Changho Cha, Seoul (KR)

(21) Appl. No.: 12/995,720

(22) PCT Filed: May 14, 2009
(86) PCT No.: PCT/KR09/02558

§ 371 Date: Dec. 2, 2010

(30) Foreign Application Priority Data
Jun. 2, 2008 (KR) 10-2008-0051674

(51) Int. Cl. G06F 3/02

(52) U.S. Cl. 345/169; 345/168

(57) ABSTRACT

A letter input device, which includes a letter input unit including alphabetical letter input keys for entering alphabetical letters, and letter creation means for selecting the alphabetical letters according to patterns in which the alphabetical letter input keys are pressed and for sequentially combining the selected alphabetical letters together. The alphabetical letter input keys include one or more alphabetical letter input keys on each of which alphabetic consonants having one or more similar distinctive features are arranged together. This configuration enables a keypad layout to be more easily learned and letters to be rapidly entered.

### TECHNICAL FIELD

The present invention relates to a Latin letter input device and a portable terminal including the device, and, more particularly, to a Latin letter input device having a keypad layout which enables the keypad layout to be easily learned and which can improve letter entry speed, and a portable terminal including the device.

### BACKGROUND ART

With the development of mobile communications, the functionality of transmitting and receiving digital information such as text has been added to voice communication-oriented portable terminals. Accordingly, the keypads which were first provided in portable terminals to enter telephone numbers have come to include means for entering letters. Meanwhile, since the size of keypads used as the input means of portable terminals has become smaller, the number of buttons included in the keypads has been limited to a small number.

Meanwhile, Latin letters also called ‘Roman letters’ are phonemic letters which are used most widely all over the world, and are basic letters which are used to record almost every European language including English. Furthermore, Latin letters are also used to enter Japanese letters or Chinese characters in portable terminals. That is, when a text message is created in a portable terminal in a language having complicated letter combination rules, a method of entering English letters having pronunciations similar to those of a corresponding language and then converting them into letters of the language is used. Since Korean includes 24 alphabetical letters, English includes 26 alphabetical letters, Japanese includes 55 alphabetical letters, and other Roman-related languages include 24 or more alphabetical letters, the number of letters of each language is considerably larger than 12 which is the number of keys included in a typical portable terminal. Accordingly, in order to enter a single alphabetical letter using the keypad of such a portable terminal, it is necessary to represent the alphabetical letter by combining one, two or more buttons of the keypad with each other.

In the English keypad of a conventional portable terminal such as a mobile terminal, English letters are arranged in alphabetical order, as shown in FIG. 1. Alternatively, a keypad in which a keypad is additionally provided to reduce the number of Latin letters arranged in a single input keypad has been used.

A conventional method of entering alphabetical letters in a small-sized keypad is a method of assigning a plurality of alphabetical letters to each of the buttons of the keypad and selectively entering the plurality of alphabetical letters assigned to the button according to the number of times that the button is pressed.

However, the conventional keypad input method shown in FIG. 1 is configured such that the number of times that a button must be pressed in order to enter a single alphabetical letter increases as the number of alphabetical letters which must be arranged on a keypad increases. That is, when three alphabetical letters are arranged on each button as in English, it is necessary to press a button twice on average in order to enter a single alphabetical letter. In contrast, when alphabetical letters are arranged on each button as in Japanese, it is necessary to press a button three times on average in order to enter a single alphabetical letter. Accordingly, when five or more alphabetical letters are assigned to each button as in Japanese, the case where the same button should be pressed five or more times in order to enter a single alphabet occurs, so that the entry of letters is inconvenient and the accuracy of entry is very low.

### DISCLOSURE

### Technical Problem

Accordingly, the present invention has been made keeping in mind the above problems occurring in the prior art, and an object of the present invention is to provide a Latin letter input device in which Latin letters are efficiently arranged in a limited keypad space, and a portable terminal using the device. Another object of the present invention is to provide a Latin letter input device which has a keypad layout which is capable of reducing the number of times that keys are pressed in a limited keypad space, and a portable terminal using the device. A further object of the present invention is to provide a Latin letter input device which includes a keypad layout which enables the layout of Latin letters to be easily learned, and a portable terminal using the device.

### Technical Solution

A Latin letter input device of the present invention includes a letter input unit including alphabetical letter input keys for entering alphabetical letters, and letter creation means for selecting the alphabetical letters according to patterns in which the alphabetical letter input keys are pressed and for sequentially combining the selected alphabetical letters together, wherein the alphabetical letter input keys include one or more alphabetical letter input keys on each of which alphabetic consonants having one or more similar distinctive features.

The letter input unit may further include at least one special character input key to which a special character other than the alphabetical letters is assigned, and the letter creation means may select any one of alphabetical letters arranged on each of the alphabetical letters keys in response to entry of the special character.

The distinctive features may include at least one of a manner of articulation, a place of articulation, a status of vibrations of vocal cords, and a sound spectrum.

Alphabetical letters which belong to one of English alphabetical letter groups ‘BMP,’ ‘CSZ,’ ‘DT,’ ‘LN,’ ‘FV,’ ‘GK,’ and ‘RWQ’ may be arranged together on each of the alphabetical letter input keys.

The letter input unit may further include at least one special character input key to which a special character other than the alphabetical letters is assigned, and the letter creation means may successively select an alphabetical letter, which is entered along with the special character, twice.

The letter input unit may further include at least one special character input key to which a special character other than the alphabetical letters is assigned, and the letter creation means may convert an alphabetical letter, which is entered along with the special character, into a special alphabetical letter in another form and then select the special alphabetical letter.

The letter input unit may further include at least one special character input key to which a special character other than the alphabetical letters is assigned, and the letter creation means may successively select an alphabetical letter, which is entered along with the special character, twice, or convert an alphabetical letter, which is entered along with the special character, into a special alphabetical letter in another form and then selects the special alphabetical letter, depending on whether the special character input key is entered once or is successively entered twice.

One or more of symbols, including a comma, a question mark, an exclamation point and a period, may be additionally arranged on each of some of the alphabetical letter input keys.

Another Latin letter input device of the present invention includes a letter input unit including a plurality of alphabetical letter input keys on which alphabetical letters are divided and arranged, and letter creation means for selecting the alphabetical letters according to patterns in which the alphabetical letter input keys are pressed and sequentially combining the selected alphabetical letters together, wherein alphabetical letters which belong to one of English alphabetical letter groups ‘BMP,’ ‘CSZ,’ ‘DT,’ ‘LN,’ ‘FV,’ ‘GK,’ and ‘RWQ’ are arranged together on each of one or more of the plurality of alphabetical letter input keys, and alphabetical letters which do not belong to the alphabetical letter groups are divided and arranged in alphabetical letter groups each having two alphabetical letters.

The letter input unit may further include at least one special character input key to which a special character other than the alphabetical letters is assigned, and the letter creation means may select any one of alphabetical letters arranged on each of the alphabetical letters keys in response to entry of the special character.

The distinctive features may include one or more of the manner of articulation, the place of articulation, the status of the vibrations of vocal cords, and a sound spectrum.

The letter input unit may further include at least one special character input key to which a special character other than the alphabetical letters is assigned, and the letter creation means may successively select an alphabetical letter, which is entered along with the special character, twice.

The letter input unit may further include at least one special character input key to which a special character other than the alphabetical letters is assigned, and the letter creation means may convert an alphabetical letter, which is entered along with the special character, into a special alphabetical letter in another form and then select the special alphabetical letter.

The letter input unit may further include at least one special character input key to which a special character other than the alphabetical letters is assigned, and the letter creation means may successively select an alphabetical letter, which is entered along with the special character, twice, or convert an alphabetical letter, which is entered along with the special character, into a special alphabetical letter in another form and then select the special alphabetical letter, depending on whether the special character input key is entered once or is successively entered twice.

One or more of symbols, including a comma, a question mark, an exclamation point and a period, may be additionally arranged on each of some of the alphabetical letter input keys.

Meanwhile, a portable terminal of the present invention includes the Latin letter input device set forth in any one of claims 1 to 15, and a communication unit configured to perform data communication with a base station in order to send a message created in the Latin letter input device.

Another portable terminal of the present invention includes keypad which includes ten alphabetical letter input keys for entering alphabetical letters and at least one special character input key for entering a special character, the portable terminal creating letters in response to key presses performed on the keypad and sending the created letters to an outside, wherein alphabetical letters which belong to one of English alphabetical letter groups ‘BMP,’ ‘CSZ,’ ‘DT,’ ‘LN,’ ‘FV,’ ‘GK,’ and ‘RWQ’ are arranged together on each of one or more of the ten alphabetical letter input keys, and the special character input key is used to select any one of alphabetical letters arranged on each of the alphabetical letter input keys.

### ADVANTAGEOUS EFFECTS

According to the present invention, the following advantages are achieved.

A Latin letter input device and a portable terminal in which Latin letters are efficiently arranged in a limited keypad space can be provided. Furthermore, a Latin letter input device which has a keypad layout which is capable of reducing the number of times that keys are pressed in a limited keypad space, and a portable terminal using the device can be provided. Moreover, according to the present invention, the layout of Latin letters can be more easily learned than that of the conventional keypad, and rapid letter entry can be achieved.

### DESCRIPTION OF DRAWINGS

FIG. 1 is a diagram illustrating an English keypad layout using a conventional English letter input method;

FIG. 2 is a diagram showing a Latin letter input device according to an embodiment of the present invention;

FIG. 3 is a diagram illustrating the keypad structure of the Latin letter input device according to an embodiment of the present invention; and

FIG. 4 is a diagram illustrating a portable terminal according to an embodiment of the present invention.

### MODE FOR INVENTION

The present invention will be described in detail below with reference to the accompanying drawings. Here, repeated descriptions and detailed descriptions of well-known functionalities and configurations which may unnecessarily make the gist of the present invention unclear will be omitted. The embodiments of the present invention are provided to more completely describe the present invention to those having ordinary knowledge. Accordingly, in the drawings, the shapes and sizes of elements may be overdrawn so as to provide a clearer illustration.

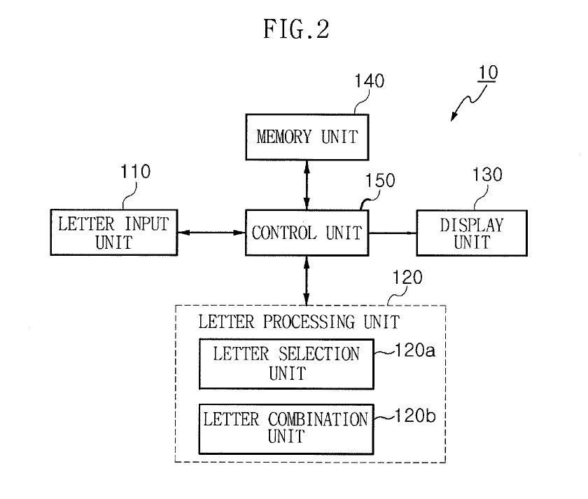

FIG. 2 is a diagram showing a Latin letter input device according to an embodiment of the present invention.

Although in the following embodiments, English will be taken as an example, it will be readily understood by those having ordinary knowledge in the related field that the present invention can be applied not only to languages including Latin letters and having meanings depending on the enumeration of alphabetical letters (for example, German, French, Spanish, Italian, and Portuguese) but also to all alphabets (for example, the Cyrillic alphabet or the like) having the same root as the Latin alphabet, in addition to English.

A Latin letter input device 10 according to an embodiment of the present invention includes a letter input unit 110, a letter processing unit 120, a display unit 130, memory 140, and a control unit 150.

1. Letter Input Unit 110

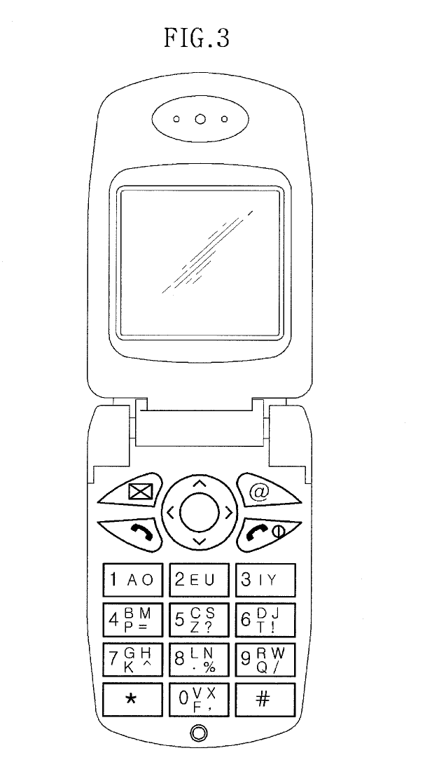

The letter input unit 110 includes a keypad (refer to FIG. 3) which includes 10 alphabetical letter input keys 0-9 configured to enter the vowels A, E, I, O, U, and Y and consonants of the English alphabet and special character input keys ‘*’ and ‘#’.

Each of the 10 alphabetical letter input keys 0-9 is assigned a plurality of alphabetical letters according to the following principle of the present invention. The principle of the present invention is established based on the fact that alphabetical letters using Roman letters can be classified and arranged according to their distinctive feature. Furthermore, the principle is established based on the fact that although there may be no significant difference between classification based on the type of articulation in pronunciation and classification based on the distinctive feature in the case of English, there may be a significant difference between classification based on the type of articulation in pronunciation and classification based on the distinctive feature in the case of other languages using Roman letters.

In the present specification, the term ‘distinctive feature’ refers to a sonic feature which can be used to distinguish between one sonic form and another sonic form based only on the difference thereof. This concept was developed based on the view that a phoneme is further divided and is a bundle of distinctive features, which contrasts with the concept of the conventional linguistics that the smallest unit of sound is a phoneme. Distinctive features may be classified into two types. The first type of distinctive features are articulatory features based on the manner of articulation, the place of articulation and the status of the vibrations of the vocal cords, and the second type of distinctive feature is a sonic feature based on a feature regarding frequencies on which sound spectrum energy concentrates, which was introduced with the development of phonetic test equipment. In an embodiment of the present invention, the principle of a keypad layout will be described based on the articulatory ones of the distinctive features, which deal with the manner of articulation, the place of articulation and the status of the vibrations of the vocal cords as features.

A keypad layout according to an embodiment of the present invention will now be described with reference to FIG. 3.

First, in order to visually understand the principle of the keypad layout based on distinctive features according to the present invention, the consonants of the English alphabet are classified according to their manner of articulation and place of articulation, as listed in the following Table 1:

TABLE 1

| | | | | palato- | | |
|---|---|---|---|---|---|---|
| | bilabial | labiodental | alveolar | dental | velar | glottal |
| plosive | B P | | D T | | G K | |
| fricative | | V F | C S Z | J | Q | H |
| nasal | M | | N | | | |
| lateral | | | L | | | |
| approximant | | | R | Y | W | |

In the keypad layout of FIG. 3, the Roman letters ‘B’, ‘M’ and ‘P’ are assigned to a single input key. Although the Roman letters ‘B and P’ are different from ‘M’ in that ‘B and P’ are plosives and ‘M’ is a nasal in terms of the manner of articulation, they have the common feature of being bilabials in terms of the place of articulation. That is, ‘B,’ ‘M,’ and ‘P’ have the same distinctive feature in terms of the distinctive feature of the place of articulation. Accordingly, in this embodiment of the present invention, these Roman letters are assigned to a single input key. Here, the plosive is a bursting sound that is made by abruptly opening an articulation organ which continuously blocks exhalation performed by lungs, and the nasal is a sound that is made when air is allowed to pass through the nose by blocking any one part of the oral cavity and lowering the soft palate. Furthermore, the bilabial is a sound that is articulated using the upper and lower lips.

The Roman letters ‘C’, ‘S’ and ‘Z’ are assigned to a single input key. The Roman letters ‘C’, ‘S’ and ‘Z’ has the same distinctive features in that they are all fricatives and alveolars in terms of the manner of articulation and the place of articulation. Accordingly, in this embodiment of the present invention, these Roman letters are assigned to a single input key. Here, a fricative is a sound which is made using friction which is generated by air while the air is passing through a narrow gap when a consonant is pronounced. Meanwhile, the alveolar refers to a gum sound.

The Roman letters ‘D’ and ‘T’ are assigned to a single input key. The Roman letters ‘D’ and ‘T’ have the same distinctive features in that they are all plosives and alveolars in terms of the manner of articulation and the place of articulation. Accordingly, in this embodiment of the present invention, these Roman letters are assigned to a single input key.

The Roman letters ‘G’, ‘K’ and ‘H’ are assigned to a single input key. The Roman letters ‘G and K’ have the same distinctive features in that they are all plosives and velars in terms of the manner of articulation and the place of articulation. However, the Roman letter ‘H’ is somewhat different from the Roman letters ‘G and K’ in that the Roman latter ‘H’ is a fricative and a glottal in terms of the manner of articulation and the place of articulation. However, the Roman letter ‘H’ is similar to the Roman letters ‘G and K’ in terms of the place of articulation in that the glottal and the velar are all articulated inside the oral cavity, and the Roman letter ‘H’ and the Roman letters ‘G and K’ have the common feature in that the plosives and the fricative are obstruents. An obstruent refers to a sound which is made by the obstruction of an articulation organ, and obstruents collectively refer to plosives and fricatives. Accordingly, since the Roman letters ‘G and K’ and ‘H’ have similar distinctive features, they are assigned to a single input key in this embodiment of the present invention. The velar is a sound which is made when the rear part of a tongue comes into contact with the soft palate located behind the hard palate.

The Roman letters ‘L and N’ are assigned to a single input key. The Roman letters ‘L and N’ have a common feature in that they are alveolars in terms of the place of articulation. However, they are different from each other in that the Roman letter ‘N’ is a nasal and the Roman letter ‘L’ is a lateral in terms of the manner of articulation. However, the nasal and the lateral have a common feature in that they are all articulated by closing the oral cavity. Here, the nasal is articulated by making a sound using the nose while closing the oral cavity, and the lateral is an approximant which is made when the center path of the oral cavity is blocked and therefore air comes out through both sides of a tongue. Accordingly, the Roman letters ‘L’ and ‘N’ are considered to be similar to each other in terms of the distinctive feature, so that they are assigned to a single input key in this embodiment of the present invention.

The Roman letters ‘R, W and Q’ are assigned to a single input key. In terms of the place of articulation, the Roman letter ‘Q’ and the Roman letter ‘W’ have the same distinctive feature in that they are velars. Although the Roman letter ‘R’ is classified as an alveolar, the Roman letter ‘R’ and the Roman letters ‘W and Q’, which are velars, have a common feature in that they are articulated in the teeth ridge near the soft palate, in terms of the place of articulation. Accordingly, in this embodiment of the present invention, the Roman letters ‘R, W and Q’ are assigned to a single input key.

The Roman letter ‘V’ and the Roman letter ‘F’ are assigned to a single input key. The Roman letters ‘D’ and ‘T’ have the same distinctive features in that they are all fricatives and labiodentals in terms of the manner of articulation and the place of articulation. Accordingly, in this embodiment of the present invention, these Roman letters are assigned to a single input key.

Meanwhile, in this embodiment of the present invention, ‘J’ is assigned to the ‘6’ key. Since is a palato-alveolar and a fricative and has a low frequency of entry, it is assigned to the empty ‘6’ key along with the Roman letters ‘D and T.’

Furthermore, in this embodiment of the present invention, ‘X’ is assigned to the ‘0’ key. Since the Roman letter ‘X’ has a low frequency of entry like the Roman letter ‘J’, it is assigned to the empty ‘0’ key along with ‘V and F.’ However, the locations of the Roman letters ‘J’ and ‘X’ are not limited to the above-described locations, and the Roman letters ‘J’ and ‘X’ are arranged along with other letters depending on the frequency of their entry or according to consideration for space utilization.

Furthermore, in this embodiment of the present invention, the Roman vowels ‘A and O,’ ‘E and U’ and ‘I and Y’ are respectively assigned to a single input key. Although in this embodiment of the present invention, the above-described groups of Roman vowels are respectively assigned to the ‘1,’ ‘2’ and ‘3’ keys of FIG. 3, the locations are not limited thereto, but it is apparent that the locations may vary depending on the frequency of entry of letters performed by people who is using the letters. For example, the groups of Roman vowels ‘A and O,’ ‘E and U’ and ‘I and Y’ may be assigned to the ‘7,’ ‘8’ and ‘9’ keys of FIG. 3, or may be respectively assigned to the ‘2,’ ‘5’ and ‘8’ keys.

Meanwhile, it is apparent that it is not necessary to assign alphabetical letters having the same or similar distinctive features to all of the alphabetical letter input keys and it is possible to assign alphabetical letters having the same or similar distinctive features to some of the alphabetical letter input keys when necessary.

Furthermore, according to the present invention, Cyrillic letters, which are used by the eastern European countries including Russia, may be classified depending on corresponding distinctive features, and be assigned to individual keys. Furthermore, it is apparent that the classification depending on the distinctive features may vary according to the characteristics of each language.

When letters having the same and/or similar distinctive features are concentrated on a single input key, there is the advantage of a user more easily learning a keypad layout in which classification depending on distinctive features has been established. For example, although it is difficult to find a correlation with respect to shape between the Russian letters IO, [symbol] and E, the above-described letters IO, [symbol] and E are pronounced as [ju], [ja] and [je], respectively, and are all alveolars, so that they are the same in terms of the sonic characteristics and the place of articulation. Accordingly, according to the principle of the keypad layout of the present invention, it is possible to assign the Russian letters IO, [symbol] and E to a single input key.

Accordingly, since these letters have similar distinctive features, they can be assigned to a single input key, a user who is using Russian can more easily learn the keypad layout, and rapid letter entry can be achieved.

Furthermore, special characters (symbols) including punctuation marks, such as a comma, a period, a question mark and an exclamation point, may be assigned to some of the alphabetical letter input keys depending on the characteristics of each language (refer to FIG. 3). Accordingly, when a text message is created, it is not necessary to select special characters in a separate screen, so that letter entry speed can be increased.

The letters which belong to the alphabetical letters assigned to each key and which are disposed in a first row are sequentially and alternately selected when the key is repeatedly pressed. For example, when the ‘4’ key to which ‘B, M, P, and =’ have been assigned in two rows is repeatedly pressed, ‘B’ and ‘M’ are sequentially and alternately selected.

Meanwhile, one of the special character input keys (for example, the ‘*’ key) is used to select an alphabetical letter or a special character disposed in the second row of each input key. For example, when the alphabetical letter ‘B’ is entered and subsequently the special character ‘*’ is entered, ‘P’ disposed in the row below the row to which ‘B’ has been assigned. Furthermore, when the alphabetical letter ‘M’ is entered and subsequently the special character ‘*’ is entered, the special character ‘=’ assigned to the row below the row to which ‘M’ has been assigned is selected. In summary, when the ‘4’ key is pressed once, the alphabetical letter ‘P’ is selected. In this state, when the ‘4’ key is pressed once more, the alphabetical letter ‘M’ is selected. Then, when the special character ‘*’ key is pressed once more, ‘P’ is selected. This alphabetical letter selection method according to the present invention is applied to all of the keys having a two-row keypad layout structure shown in FIG. 3 (the ‘4’ to ‘9’ keys and the ‘0’ key).

Meanwhile, referring to the ‘4,’ ‘5,’ ‘6,’ and ‘0’ keys of FIG. 3, the voiced sounds B, D, G, and K are assigned to these keys, respectively, and the voiceless sound P, T, K, and F are assigned to these keys, respectively. When a key having a two-row keypad layout structure is pressed once, a voiced sound may be selected. When the special character is subsequently pressed, a voiceless sound may be selected. For example, when the voiced sound ‘D’ is entered and subsequently the special character ‘*’ is entered, the voiced sound ‘T’ assigned to the row below the row to which the voiced sound ‘D’ has been assigned is selected. Of course, it is possible to enable reverse selection to be performed. The voiced sound is also referred to as a sonant, and is a sound which is accompanied by the vibrations of the vocal cords when the sound is articulated. In contrast, the voiceless sound is a sound which does not vibrate the vocal cords when the sound is articulated.

As described above, a user can easily learn the keypad layout of the present invention based on the distinctive features, and therefore the letter entry speed of the keypad can be improved. Furthermore, when a user desires to select a consonant, any consonant can be selected in one or two presses, so that the number of key presses is reduced to ⅔ of the number of key presses of the conventional keypad. There is a total of 393,144 letters included in the 48,118 English words that are most frequently used. In the conventional method, the number of key presses required to enter all of the 393,144 letters is 869,293.

In contrast, in the present invention, the number of key presses required to enter all of the 393,144 letters is 572,793. The present invention is configured to enter 393,144 letters included in 48,118 words having high frequencies of use using a number of presses of keys corresponding to 65.9% of the number of key presses for the conventional technology, so that the speed of the entry can be increased.

The following Table 2 lists the number of presses for each of the letters which is required to enter 393,144 letters included in 48,118 words having high frequencies of simple use.

TABLE 2

| | |
|---|---|
| A | 33,863 |
| B | 8,437 |
| C | 17,042 |
| D | 13,648 |
| E | 44,369 |
| F | 12,500 |
| G | 9,275 |
| H | 19,772 |
| I | 33,148 |
| J | 2,442 |
| K | 8,080 |
| L | 21,478 |
| M | 22,104 |
| N | 55,012 |
| O | 53,062 |
| P | 23,130 |
| Q | 1,594 |
| R | 28,686 |
| S | 47,082 |
| T | 55,770 |
| U | 28,604 |
| V | 4,363 |
| W | 8,314 |
| X | 2,230 |
| Y | 16,208 |
| Z | 2,580 |
| Total | 572,793 |

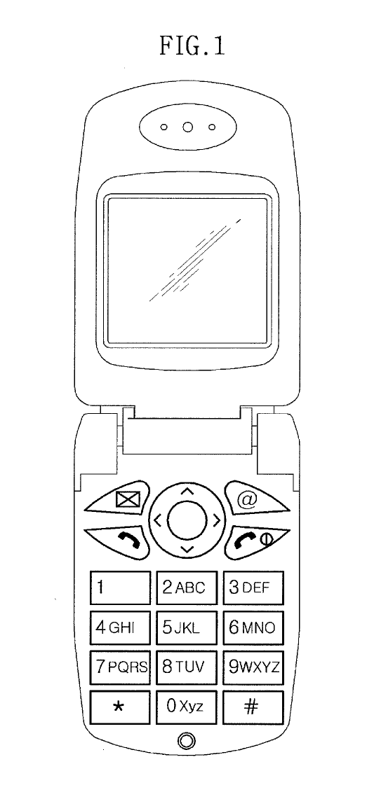

Furthermore, another of the special character input keys (for example, the ‘#’ key) may be used to enter repetitive letters. For example, when the alphabetical letter input key ‘M’ is pressed and then the special character input key ‘#’ is pressed, ‘MM’ is entered. Accordingly, according to the present invention, keys are pressed in the order of ‘5-11-44-#-2-88-6*’ in order to enter the word ‘COMMENT.’ In contrast, in the conventional alphabetical letter input method (refer to FIG. 1), in order to enter the word ‘COMMENT,’ keys are pressed in the order of ‘3-666-space-6-space-6-33-66-8’, or waiting for a predetermined period of time must be performed instead of pressing a space key (the ‘>’ key of the keypad of the mobile phone shown in FIG. 1). Accordingly, according to the letter input method of the present invention, the number of key presses is reduced and input speed is increased. Furthermore, a special character input key (for example, the ‘#’ key) may be used as an Enter key after letters (for example, ‘address’) have been selected in SMS.

Meanwhile, when a special character input key (for example, the “*” key) is not used to select alphabetical letters arranged in the second rows of the keys, alphabetical letters assigned to each of the keys may be sequentially and alternately selected when the key is repeatedly pressed. For example, when the ‘4’ key to which ‘B, M, P, and =’ are assigned is repeatedly pressed, ‘B,’ ‘M,’ ‘P,’ and ‘=’ may be sequentially and alternately selected. However, in this case, the number of key presses and the letter entry speed are hardly improved compared to the conventional technology.

Meanwhile, a special character input key (for example, the ‘*’ key) may be used to select special alphabetical letters (for example, alphabetical letters in which umlauts are put above vowels) that fall outside the 26 alphabetical letters, as is the case for German or Swedish. For example, when the vowel ‘A’ is pressed and then the special character input key ‘*’ is pressed, the A umlaut Å is selected. Accordingly, in the present specification, the term ‘special alphabetical letter’ may be defined as a variation of a corresponding alphabet consonant or vowel which is formed by adding a symbol, other than alphabetical letters, to the alphabetical consonant or vowel. Furthermore, when the vowel ‘A’ is pressed and then the special character input key ‘*’ is pressed, ‘AA’ may be selected. Furthermore, when the vowel ‘A’ is pressed and the special character input key ‘*’ is successively pressed twice, the ‘A umlaut’ may be selected. In this case, when the special character input key ‘*’ is repeatedly pressed, ‘AA’ and the ‘A umlaut’ are sequentially and alternately selected and displayed on a screen. For example, when the ‘*’ key is pressed once, ‘AA’ is displayed on the screen. When the ‘*’ key is pressed twice, the ‘A umlaut’ is displayed on the screen. When the ‘*’ key is pressed three times, ‘AA’ is displayed on the screen again. When the ‘*’ key is pressed four times, the ‘A umlaut’ is displayed on the screen again.

Meanwhile, the special alphabetical letters Å, Ñ and Õ, other than umlaut letters, may be selected using the ‘*’ key depending on the language. Furthermore, in order to represent a plurality of special alphabetical letters, when the ‘*’ key is repeatedly pressed, the plurality of special alphabetical letters may be sequentially and repeatedly selected.

2. Letter Processing Unit 120

The letter processing unit 120 includes a letter selection unit 120a configured to select alphabetical letters according to keypress patterns input using the letter input unit 110 and a letter combination unit 120b configured to sequentially combine the selected letters together. The letter processing unit 120 forms the letter creation means of the present invention, along with a memory unit 140 and a control unit 150, which will be described later.

The letter selection unit 120a selects letters according to keypress patterns input using the letter input unit 110. A letter selection method used by the letter selection unit 120a of the present embodiment will now be described.

<Vowel Selection Method>

The vowels A, E, I, O, U and Y are sequentially and alternately selected when a corresponding input key is repeatedly pressed. When the ‘AO’ key is pressed, ‘A’ and ‘O’ are sequentially and alternately selected. When the ‘EU’ key is pressed, ‘E’ and ‘U’ are sequentially and alternately selected. Furthermore, the special character input key ‘*’ is used to select special alphabetical letters such as diphthongs and umlaut vowels. The vowel selection method according to the present embodiment is summarized in the following Table 3. In Table 3, numbers are numbers which are assigned to the keypad of FIG. 3.

TABLE 3

| | | | Selection of special |
|---|---|---|---|
| | Selection of vowel | Selection of diphthong | alphabetical letter |
| A | 1 | A-* | A-** |
| E | 2 | E-* | E-** |
| I | 3 | I-* | I-** |
| O | 11 | O-* | O-** |
| U | 22 | U-* | U-** |
| Y | 33 | Y-* | Y-** |

<Consonant Selection Method>

Those of the alphabetical letters assigned to the input keys and disposed in first rows are sequentially and alternately selected when the input keys are repeatedly pressed. For example, when the ‘4’ key to which ‘B, M, P, and =’ have been assigned in two rows is repeatedly pressed, ‘B’ and ‘M’ are sequentially and alternately selected.

Furthermore, one of the special character input keys (for example, the ‘*’ key) is used to select alphabetical letters or special characters disposed in the second rows on the input keys. For example, when the alphabetical letter ‘B’ is entered and subsequently the special character ‘*’ is entered, ‘P’ assigned to the location of the second row below the location of the first row to which ‘B’ has been assigned is selected. Meanwhile, when the alphabetical letter ‘M’ is entered and then the special character ‘*’ is entered, the special character ‘=’ assigned to the location of the second row below the location to which ‘M’ has been assigned is determined. In summary, when the ‘4’ key is pressed, the alphabetical letter ‘P’ is selected. At this time, when the ‘4’ key is pressed again, the alphabetical letter ‘M’ is selected. In this case, when the special character ‘*’ key is pressed, ‘P’ is selected.

Furthermore, the special character input key ‘#’ is used to select repetitive consonants. In particular, in English, repetitive consonants are frequency used in order to preserve the forms of single vowels in the event of tense or participial conversion (for example, shopped (shop) and manning (man)), so that the repetitive consonant selection method according to an embodiment of the present invention will be very useful.

3. Display Unit 130

The display unit 130 is a display device which outputs keypress signals, input using the letter input unit 110, or control signals, output by the control unit 150, to the outside and which is configured of a Liquid Crystal Display (LCD), a Plasma Display Panel (PDP), or Organic Light Emitting Diodes (OLED). The display unit 130 is a selective component in the letter input device 10 of the present invention. The display unit 130 displays the process of combining letters in real time, thereby enabling a user to perceive the process of combining the letters.

4. Memory Unit 140 and Control Unit 150

Programs configured to control the overall operation of the Latin letter input device 10, including a program configured to execute the selection/combination method according to an embodiment of the present invention, are registered in the memory unit 140, and the control unit 150 controls the operation of the Latin letter input device 10 by running the programs registered in the memory unit 140. That is, the control unit 150 controls the Latin letter input device 10 so that letters are created and displayed by the letter selection/processing method, and further controls the Latin letter input device 10 so that corresponding functionality which is set by assigning a special character to a key can be performed. Meanwhile, although in the embodiment of the present invention, the operation of the letter input device of the present invention has been implemented by software programs registered in the memory unit 140 in software form, it is possible to implement the operation of the Latin letter input device 10 of the present invention using well-known hardware implementation technology in hardware form.

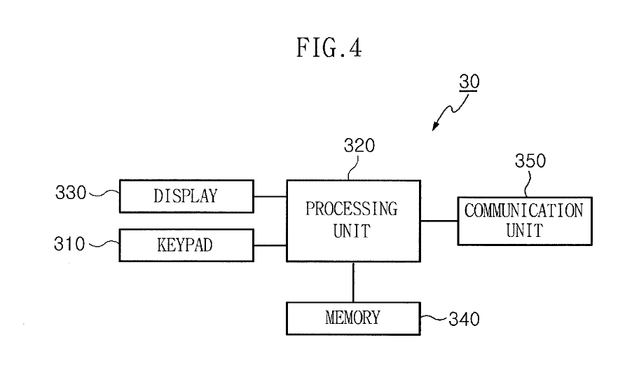

FIG. 4 shows a function block diagram of a portable terminal 30 which contains the Latin letter input device of the present invention. In general, the portable terminal, which generally includes a cellular phone, a personal communication system terminal, a PDA, an IMT-2000 terminal, a PMP, an MP3 player, and an interactive remote control, includes a keypad 310, a processing unit 320, a display 330, memory 340, and a communication unit 350. Here, the communication unit 350 may be selected depending on the type of terminal. The communication unit 350 is configured of a communication circuit, and communicates with a base station to perform voice communication and various types of data communication. The other components cooperate with each other in the functional aspect in order to implement the Latin letter input device 10 of the present invention. That is, the functionalities of the letter input unit 110, letter processing unit 120, display unit 130, and memory 140 of the Latin letter input device 10 are implemented by the keypad 310, processing unit 320, display 330 and memory 340 of the portable terminal, and the processing unit 320 of the portable terminal performs the functionality of the control unit 150 of the letter input device 10. Furthermore, the portable terminal 30 further includes an antenna, a microphone and a speaker which are used to perform data communication and voice communication, in addition to the components shown in FIG. 3.

The present invention may be implemented in any of computer-readable storage media using computer-readable code. Such computer-readable storage media include all types of storage devices which can store data that can be read by a computer system. Examples of the computer-readable storage media may include ROM, RAM, CD-ROM, magnetic tapes, floppy disks and optical data storage devices. Furthermore, the computer-readable storage media include an implementation in the form of carrier waves (for example, in the case of Internet transmission). Furthermore, such a computer-readable storage medium may be distributed among systems connected over a network, and store and execute computer-readable code in a distributed manner.

As described above, the preferred embodiments are disclosed in the drawings and the specification. Although in the specification, specific terms have been used, they have been used only for the purpose of illustrating the present invention, and have not been used to limit the meanings of related content or the scope of the present invention described in the claims. Therefore, it will be apparent to those having ordinary knowledge in the technology field that a variety of variations and other equivalent embodiment are possible. Accordingly, the true range of the technical protection of the present invention should be determined based on the technical spirit of the attached claims.

1. A letter input device, comprising:
a letter input unit comprising alphabetical letter input keys for entering alphabetical letters; and
letter creation means for selecting the alphabetical letters according to patterns in which the alphabetical letter input keys are entered and for sequentially combining the selected alphabetical letters together;
wherein the alphabetical letter input keys comprise one or more alphabetical letter input keys on each of which alphabetic consonants having similar distinctive features are arranged together.

2. The letter input device as set forth in claim 1, wherein:
the letter input unit further comprises at least one special character key to which a special character other than the alphabetical letters is assigned; and
the letter creation means selects any one of alphabetical letters arranged on each of the alphabetical letters keys in response to entry of the special character.

3. The letter input device as set forth in claim 1 or 2, wherein the distinctive features comprise at least one of a manner of articulation, a place of articulation, a status of vibrations of vocal cords, and a sound spectrum.

4. The letter input device as set forth in claim 1 or 2, wherein alphabetical letters which belong to one of English alphabetical letter groups ‘BMP,’ ‘CSZ,’ ‘DT,’ ‘LN,’ ‘FV,’ ‘GK,’ and ‘RWQ’ are arranged together on each of the alphabetical letter input keys.

5. The letter input device as set forth in claim 1, wherein:
the letter input unit further comprises at least one special character key to which a special character other than the alphabetical letters is assigned; and
the letter creation means successively selects an alphabetical letter, which is entered along with the special character, repeatedly.

6. The letter input device as set forth in claim 1, wherein:
the letter input unit further comprises at least one special character input key to which a special character other than the alphabetical letters is assigned; and
the letter creation means converts an alphabetical letter, which is entered along with the special character, into a special alphabetical letter in another form and then selects the special alphabetical letter.

7. The letter input device as set forth in claim 1, wherein:
the letter input unit further comprises at least one special character input key to which a special character other than the alphabetical letters is assigned; and
the letter creation means successively selects an alphabetical letter, which is entered along with the special character, repeatedly, or converts an alphabetical letter, which is entered along with the special character, into a special alphabetical letter in another form and then selects the special alphabetical letter, depending on whether the special character input key is entered once or is successively entered twice.

8. The letter input device as set forth in claim 1 or 2, wherein one or more of symbols, including a comma, a question mark, an exclamation point and a period, are additionally arranged on each of some of the alphabetical letter input keys.

9. A letter input device, comprising:
a letter input unit comprising a plurality of alphabetical letter input keys on which alphabetical letters are divided and arranged; and
letter creation means for selecting the alphabetical letters according to patterns in which the alphabetical letter input keys are entered and sequentially combining the selected alphabetical letters together;
wherein alphabetical letters which belong to one of English alphabetical letter groups ‘BMP,’ ‘CSZ,’ ‘DT,’ ‘LN,’ ‘FV,’ ‘GK,’ and ‘RWQ’ are arranged together on each of one or more of the plurality of alphabetical letter input keys, and alphabetical letters which do not belong to the alphabetical letter groups are divided and arranged in alphabetical letter groups each having two alphabetical letters.

10. The letter input device as set forth in claim 9, wherein:
the letter input unit further comprises at least one special character key to which a special character other than the alphabetical letters is assigned; and
the letter creation means selects any one of alphabetical letters arranged on each of the alphabetical letters keys in response to entry of the special character.

11. The letter input device as set forth in claim 9, wherein the alphabetical letter groups ‘BMP,’ ‘CSZ,’ ‘DT,’ ‘LN,’ ‘FV,’ ‘GK,’ and ‘RWQ’ are arranged based on one or more distinctive features including manners of articulation, places of articulation, statuses of vibrations of vocal cords, and/or sound spectra.

12. The letter input device as set forth in claim 9, wherein:
the letter input unit further comprises at least one special character key to which a special character other than the alphabetical letters is assigned; and
the letter creation means successively selects an alphabetical letter, which is entered along with the special character, repeatedly.

13. The letter input device as set forth in claim 9, wherein:
the letter input unit further comprises at least one special character input key to which a special character other than the alphabetical letters is assigned; and
the letter creation means converts an alphabetical letter, which is entered along with the special character, into a special alphabetical letter in another form and then selects the special alphabetical letter.

14. The letter input device as set forth in claim 9, wherein:
the letter input unit further comprises at least one special character input key to which a special character other than the alphabetical letters is assigned; and
the letter creation means successively selects an alphabetical letter, which is entered along with the special character, repeatedly, or converts an alphabetical letter, which is entered along with the special character, into a special alphabetical letter in another form and then selects the special alphabetical letter, depending on whether the special character input key is entered once or is successively entered twice.

15. The letter input device as set forth in claim 9, wherein one or more of symbols, including a comma, a question mark, an exclamation point and a period, are additionally arranged on each of some of the alphabetical letter input keys.

16. A portable terminal, comprising:
the letter input device set forth in claim 1; and
a communication unit configured to perform data communication with a base station in order to send a message created in the letter input device.

17. A portable terminal comprising a keypad which comprises ten alphabetical letter input keys for entering alphabetical letters and at least one special character input key for entering a special character, the portable terminal creating letters in response to key presses performed on the keypad and sending the created letters to an outside, wherein:
alphabetical letters which belong to one of English alphabetical letter groups ‘BMP,’ ‘CSZ,’ ‘DT,’ ‘LN,’ ‘FV,’ ‘GK,’ and ‘RWQ’ are arranged together on each of one or more of the ten alphabetical letter input keys; and
the special character input key is used to select any one of alphabetical letters arranged on each of the alphabetical letter input keys.
